(19) United States
(12) Patent Application Publication
(10) Pub. No.: US 2014/0228271 A1
(43) Pub. Date: Aug. 14, 2014

(54) DISHWASHER RINSE AIDS AND DETERGENTS

(71) Applicant: Henkel AG & Co. KGaA, Duesseldorf (DE)

(72) Inventors: Thomas Eiting, Duesseldorf (DE); Nina Mussmann, Willich (DE); Thorsten Bastigkeit, Wuppertal (DE); Konstantin Benda, Duesseldorf (DE); Claudia Ottow, Ratingen (DE)

(73) Assignee: Henkel AG & Co. KGaA, Duesseldorf (DE)

(21) Appl. No.: 14/256,295

(22) Filed: Apr. 18, 2014

Related U.S. Application Data
(63) Continuation of application No. PCT/EP2012/062826, filed on Jul. 2, 2012.

(30) Foreign Application Priority Data
Oct. 21, 2011 (DE) 10 2011 084 934.3

(51) Int. Cl. C11D 3/33

(52) U.S. Cl. CPC C11D 3/33
USPC 510/229

(57) ABSTRACT

Rinse aids and dishwashing agents that contain anionic surfactant(s) having at least one sulfate group or sulfonate group, as well as nonionic surfactant(s), produce very good drying of the dishes cleaned in an automatic dishwashing method. The automatic dishwashing agents additionally contain polycarboxylic acid in combination with methyglycinediacetic acid or glutaminediacetic acid or ethylenediaminedisuccinic acid, or salts thereof.

### FIELD OF THE INVENTION

The present invention generally relates to rinse aids and dishwashing agents as well as automatic dishwashing methods employing said agents, and the use of said aids and agents in automatic dishwashing.

### BACKGROUND OF THE INVENTION

Dishwashing agents are available to consumers in a large number of presentation forms. In addition to the traditional liquid hand dishwashing agents, automatic dishwashing agents especially have considerable significance as household automatic dishwashers have become widespread. These automatic dishwashing agents are offered to the consumer typically in solid form, for example as powders or tablets, but increasingly also in liquid form.

One of the main objectives of manufacturers of automatic cleaning agents is to improve the cleaning and rinsing performance of these agents, increased attention recently having been paid to cleaning and rinsing performance in low-temperature cleaning cycles or in cleaning cycles having reduced water consumption. In addition to the cleaning and rinsing performance of the agents, however, increasing importance is being attached to further performance advantages as well. One example of such a further performance advantage is the drying properties of the cleaning and rinsing agents that are employed. The need for additional manual re-drying of the cleaned dishes is regarded by many consumers as troublesome.

The object of this application was therefore to make available automatic rinse aids and dishwashing agents having improved drying properties, the intention being that these improved drying properties were to be achieved in particular also in low-temperature cleaning cycles, i.e. in cleaning methods having cleaning bath temperatures of 50° C. or below, and/or in short-duration cleaning methods, in particular in cleaning methods having a duration of less than 60 minutes.

This object is achieved by dishwashing agents and rinse aids that contain at least one anionic surfactant having at least one sulfate group or sulfonate group, as well as at least one nonionic surfactant.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An automatic dishwashing agent, characterized in that it contains at least one anionic surfactant having at least one sulfate group or sulfonate group, at least one nonionic surfactant, and, as builders, a combination of at least one polycarboxylic acid and at least one compound selected from methylglycinediacetic acid or salt thereof (MGDA), glutaminediacetic acid or salt thereof (GLDA), and ethylenediaminedisuccinic acid or salt thereof (EDDS).

An automatic dishwashing method, characterized in that an automatic dishwashing agent according to one of the preceding claims is employed.

Use of a combination of at least one anionic surfactant having at least one sulfate group or sulfonate group and at least one nonionic surfactant for drying dishes in an automatic cleaning method.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The existing art has already described the fact that nonionic surfactants bring about very good drying of the cleaned dishes. It was not to be expected, however, that these very good drying properties might be further enhanced by the utilization of anionic surfactants. In addition, a generally known problem with anionic surfactants is their foaming behavior. As a result of foaming when they are used, a pressure drop can occur in the automatic dishwasher, this generally being associated with insufficient cleaning performance; for this reason, the use of anionic surfactants in automatic dishwashing is usually omitted.

Surprisingly, however, it has now been ascertained according to the present invention that the drying performance of rinse aids and dishwashing agents that contain nonionic surfactants can be enhanced by the addition of surfactants having sulfate groups and/or sulfonate groups.

A first subject of the present invention is therefore the use of a combination of at least one anionic surfactant having at least one sulfate group or sulfonate group and at least one nonionic surfactant as a drying agent for dishes in an automatic cleaning method, the surfactants preferably being employed in the form of an automatic rinse aid or in the form of an automatic dishwashing agent.

Particularly good drying properties were obtainable in particular with automatic dishwashing agents when a combination of at least one polycarboxylic acid or salt thereof, in particular citrate, and at least one compound selected from methylglycinediacetic acid or salt thereof (MGDA), glutaminediacetic acid or salt thereof (GLDA), and ethylenediaminedisuccinic acid or salt thereof (EDDS), were used as builders.

A further subject of the present invention is therefore automatic dishwashing agents that contain at least one anionic surfactant having at least one sulfate group or sulfonate group, at least one nonionic surfactant and, as builders, a combination of at least one polycarboxylic acid or salt thereof, in particular citrate, and at least one compound selected from methylglycinediacetic acid or salt thereof (MGDA), glutaminediacetic acid or salt thereof (GLDA), and ethylenediaminedisuccinic acid or salt thereof (EDDS).

A further subject of the present invention is dishwashing methods employing automatic dishwashing agents according to the present invention.

“Automatic dishwashing agents” refers, as defined by this application, to compositions that can be employed to clean soiled dishes in an automatic dishwashing method. The automatic dishwashing agents therefore differ, for example, from automatic rinse aids, which are always employed in combination with automatic dishwashing agents and have no cleaning action of their own.

An “automatic rinse aid” is correspondingly to be understood according to the present invention as compositions that, besides the aforesaid surfactants and optionally acidifying agents, contain no further substances potentially having cleaning action.

While automatic rinse aids according to the present invention are preferably present in liquid form, automatic dishwashing agents in which the combination of anionic surfactants having at least one sulfate group or sulfonate group is employed are present in solid or liquid form. Solid embodiments can be particularly preferred in this context.

A “liquid dishwashing agent or rinse aid” is to be understood in this context as an agent that is present in a liquid aggregate state at 25° C. and a pressure of 1 bar. A “solid dishwashing agent or rinse aid” is correspondingly to be understood as an agent that is present in a solid aggregate state at 25° C. and a pressure of 1 bar.

In a preferred embodiment, the solid dishwashing agent is present in the form of a shaped element, in particular a compactate, especially a tablet.

The anionic surfactant having at least one sulfate group or sulfonate group is preferably selected from fatty alcohol sulfates, alkyl sulfates, fatty alcohol ether sulfates/alkyl ether sulfates, alkanesulfonates, and alkylbenzenesulfonates. Preferred in this context are C₁₂ to C₁₈ fatty alcohol sulfates (FAS), e.g. Sulfopon K 35 (BASF, Germany), C₁₂ fatty alcohol ether sulfate, e.g. Texapon N70 (BASF, Germany), secondary C₁₃ to C₁₇ alkanesulfonates (SAS), e.g. Hostapur SAS 93 (Clariant, Germany), and linear C₈ to C₁₈ alkylbenzenesulfonates, in particular dodecylbenzenesulfonate (LAS).

According to the present invention, the terms “sulfate” and “sulfonate” also comprise, besides relevant anionic compounds that are present in the form of salts, the free acids, i.e. in particular the corresponding alkylsulfuric acids or alkylsulfonic acids.

The weight proportion of the anionic surfactant in terms of the total weight of the automatic dishwashing agent or in the context of use of an automatic rinse aid is preferably from 0.1 to 20 wt %, in particular 0.5 to 15 wt %, and especially 2.5 to 10 wt %.

All nonionic surfactants known to the skilled artisan can be used as nonionic surfactants. Suitable as nonionic surfactants, for example, are alkyl glycosides of the general formula RO(G)ₓ, in which R denotes a primary straight-chain or methyl-branched (in particular methyl-branched in the 2-position) aliphatic residue having 8 to 22, preferably 12 to 18 carbon atoms; and G is the symbol denoting a glycose unit having 5 or 6 carbon atoms, preferably glucose. The degree of oligomerization x, which indicates the distribution of monoglycosides and oligoglycosides, is any number between 1 and 10; preferably, x is between 1.2 and 1.4.

A further class of nonionic surfactants used in preferred fashion, which are used either as the only nonionic surfactant or in combination with other nonionic surfactants, are alkoxylated, preferably ethoxylated or ethoxylated and propoxylated, fatty acid alkyl esters, preferably having 1 to 4 carbon atoms in the alkyl chain.

Nonionic surfactants of the amine oxide type, for example N-cocalkyl-N, N-dimethylamine oxide and N-tallowalkyl-N, N-dihydroxyethylamine oxide, and the fatty acid alkanolamides, can also be suitable. The quantity of these nonionic surfactants is preferably equal to no more than that of the ethoxylated fatty alcohols, in particular no more than half thereof.

Further suitable surfactants are polyhydroxy fatty acid amides of the formula

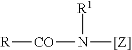

in which R denotes an aliphatic acyl residue having 6 to 22 carbon atoms; R¹ denotes hydrogen, an alkyl or hydroxyalkyl residue having 1 to 4 carbon atoms; and [Z] denotes a linear or branched polyhydroxyalkyl residue having 3 to 10 carbon atoms and 3 to 10 hydroxyl groups. The polyhydroxy fatty acid amides are known substances that can usually be obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of the formula

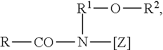

in which R denotes a linear or branched alkyl or alkenyl residue having 7 to 12 carbon atoms; R¹ denotes a linear, branched, or cyclic alkyl residue or an aryl residue having 2 to 8 carbon atoms; and R² denotes a linear, branched, or cyclic alkyl residue or an aryl residue or an oxyalkyl residue having 1 to 8 carbon atoms, C₁₋₄ alkyl or phenyl residues being preferred; and [Z] denotes a linear polyhydroxyalkyl residue whose alkyl chain is substituted with at least two hydroxyl groups, or alkoxylated, preferably ethoxylated or propoxylated, derivatives of that residue.

[Z] is preferably obtained by reductive amination of a reduced sugar, for example glucose, fructose, maltose, lactose, galactose, mannose, or xylose. The N-alkoxy- or N-aryloxy-substituted compounds can be converted into the desired polyhydroxy fatty acid amides by reaction with fatty acid methyl esters in the presence of an alkoxide as catalyst.

Low-foaming nonionic surfactants are used as preferred surfactants. With particular preference, washing or cleaning agents, in particular cleaning agents for automatic dishwashing, contain nonionic surfactants from the group of alkoxylated alcohols. Alkoxylated, advantageously ethoxylated, in particular primary alcohols having preferably 8 to 18 carbon atoms and on average 1 to 12 mol ethylene oxide (EO) per mol of alcohol, in which the alcohol residue can be linear or preferably methyl-branched in the 2-position or can contain linear and methyl-branched residues in the mixture, as are usually present in oxo alcohol residues, are preferably used as nonionic surfactants.

Nonionic surfactants that have a melting point above room temperature are particularly preferred. Nonionic surfactant(s) having a melting point above 20° C., preferably above 25° C., particularly preferably between 25 and 60° C., and in particular between 26.6 and 43.3° C., is/are particularly preferred.

Suitable nonionic surfactants that have melting or softening points in the aforesaid temperature range are, for example, low-foaming nonionic surfactants that can be solid or highly viscous at room temperature. If nonionic surfactants that are highly viscous at room temperature are used, it is then preferred that they have a viscosity above 20 Pa·s, preferably above 35 Pa·s, and in particular above 40 Pa·s. Nonionic surfactants that possess a waxy consistency at room temperature are also preferred.

Surfactants that are preferred for use derive from the groups of the alkoxylated nonionic surfactants, in particular the ethoxylated primary alcohols, and mixtures of these surfactants with surfactants of greater structural complexity, such as polyoxypropylene/polyoxyethylene/polyoxypropylene (PO/EO/PO) surfactants. (PO/EO/PO) nonionic surfactants of this kind are moreover notable for good foam control.

Further nonionic surfactants having melting points above room temperature that are particularly preferred for use contain 40 to 70% of a polyoxypropylene/polyoxyethylene/polyoxypropylene block polymer blend that contains 75 wt % of a reverse block copolymer of polyoxyethylene and polyoxypropylene with 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol trimethylolpropane.

In rinse aids according to the present invention it is preferred to use those low-foaming nonionic surfactants which comprise a linear or branched alkyl residue having 10 to 20, preferably 12 to 18 carbon atoms as well as 2 to 30, preferably 4 to 15 ethylene oxide units, and optionally up to 5 propylene oxide units and up to 5 butylene oxide units.

Nonionic surfactants of the general formula

R¹—CH(OH)CH₂O-(AO)_{w}-(A′O)ₓ-(A″O)_{y}-(A′″O)_{z}—R²,

in which R¹ and R² mutually independently denote a straight-chain or branched, saturated or monounsaturated or polyunsaturated C₂₋₄₀ alkyl or alkenyl residue; A, A′, A″, and A′″ mutually independently denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y, and z denote values between 0.5 and 120, where x, y, and/or z can also be 0, are particularly preferably used according to the present invention, in particular in automatic dishwashing agents.

Very particularly preferred in this context are nonionic surfactants of the general formula R¹O [CH₂CH(CH₃)O]ₓ[CH₂CH₂O]_{y}[CH₂CH(CH₃)O]_{z}CH₂CH(OH)R², in which R¹ denotes a linear or branched aliphatic hydrocarbon residue having 4 to 22, in particular 6 to 18 carbon atoms, or mixtures thereof, R² denotes a linear or branched hydrocarbon residue having 2 to 26, in particular 4 to 20 carbon atoms, or mixtures thereof, and x and z denote values between 0 and 40 and y denotes a value of at least 15, preferably from 15 to 120, particularly preferably from 20 to 80.

In a preferred embodiment, the automatic dishwashing agent contains, based on its total weight, nonionic surfactant of the general formula R¹O[CH₂CH(CH₃)O]ₓ[CH₂CH₂O]_{y}[CH₂CH(CH₃)O]_{z}CH₂CH(OH)R² in quantities from 0.1 to 15 wt %, preferably 0.2 to 10 wt %, particularly preferably 0.5 to 8 wt %, and in particular from 1.0 to 6 wt %.

Particularly preferred are those end-capped poly(oxyalkylated) nonionic surfactants according to the formula R¹O[CH₂CH₂O]_{y}CH₂CH(OH)R² in which R¹ denotes a linear or branched aliphatic hydrocarbon residue having 4 to 22, in particular 6 to 16 carbon atoms, or mixtures thereof, R² denotes a linear or branched hydrocarbon residue having 2 to 26, in particular 4 to 20 carbon atoms, or mixtures thereof, and y denotes a value from 15 to 120, preferably 20 to 100, in particular 20 to 80. Members of this group of nonionic surfactants include, for example, hydroxy mixed ethers of the general formula C₆₋₂₂-CH(OH)CH₂O-(EO)₂₀₋₁₂₀-C₂₋₂₆, for example C₈₋₁₂ fatty alcohol-(EO)₂₂-2-hydroxydecyl ethers and C₄₋₂₂ fatty alcohol-(EO)₄₀₋₈₀-2-hydroxyalkyl ethers.

Automatic dishwashing agents according to the present invention in which a surfactant of the general formula R¹CH(OH)CH₂O—(CH₂CH₂O)₂₀₋₁₂₀-R² is used as a low-foaming nonionic surfactant, where R¹ and R² mutually independent denote a linear or branched aliphatic hydrocarbon residue having 2 to 20, in particular 4 to 16 carbon atoms, are particularly preferred.

Also preferred are surfactants of the formula R¹O[CH₂CH(CH₃)O]ₓ[CH₂CH₂O]_{y}CH₂CH(OH)R² in which R¹ denotes a linear or branched aliphatic hydrocarbon residue having 4 to 22 carbon atoms, or mixtures thereof, R² designates a linear or branched hydrocarbon residue having 2 to 26 carbon atoms, or mixtures thereof, and x denotes values between 0.5 and 4, preferably 0.5 to 15, and y denotes a value of at least 15.

Also preferred according to the present invention are surfactants of the general formula R¹O[CH₂CH(CH₃)O]ₓ[CH₂CH₂O]_{y}CH₂CH(OH)R² in which R¹ denotes a linear or branched aliphatic hydrocarbon residue having 4 to 22 carbon atoms, or mixtures thereof, R² designates a linear or branched hydrocarbon residue having 2 to 26 carbon atoms, or mixtures thereof, and x denotes a value between 1 and 40 and y denotes a value between 15 and 40, where the alkylene units [CH₂CH(CH₃)O] and [CH₂CH₂O] are present in randomized fashion, i.e. in the form of a statistical, random distribution.

Also belonging to the group of the preferred end-capped poly(oxyalkylated) nonionic surfactants are nonionic surfactants of the formula R¹O[CH₂CH₂O]ₓ[CH₂CH(R³)O]_{y}CH₂CH(OH)R² in which R¹ and R² mutually independently denote a linear or branched, saturated or monounsaturated or polyunsaturated hydrocarbon residue having 2 to 26 carbon atoms, R³ is selected mutually independently from —CH₃, —CH₂CH₃, —CH₂CH₂—CH₃, —CH(CH₃)₂, but preferably denotes —CH₃, and x and y mutually independently denote values between 1 and 32, wherein nonionic surfactants where R³═—CH₃ and having values for x from 15 to 32 and for y from 0.5 to 1.5 are very particularly preferred.

Further nonionic surfactants preferred for use are the end-capped poly(oxyalkylated) nonionic surfactants of the formula

R¹O[CH₂CH(R³)O]ₓ[CH₂]ₖCH(OH)[CH_{2]}ⱼOR²

in which R¹ and R² denote linear or branched, saturated or unsaturated, aliphatic or aromatic hydrocarbon residues having 1 to 30 carbon atoms, R³ denotes hydrogen or a methyl, ethyl, n-propyl, isopropyl, n-butyl, 2-butyl, or 2-methyl-2-butyl residue, x denotes values between 1 and 30, k and j denote values between 1 and 12, preferably between 1 and 5. If the value of x is ≧2, each R³ in the above formula R¹O[CH₂CH(R³)O]ₓ[CH₂]ₖCH(OH)[CH₂]ⱼOR² can be different. R¹ and R² are preferably linear or branched, saturated or unsaturated, aliphatic or aromatic hydrocarbon residues having 6 to 22 carbon atoms, residues having 8 to 18 carbon atoms being particularly preferred. Hydrogen, —CH₃, or —CH₂CH₃ are particularly preferred for the residue R³. Particularly preferred values for x are in the range from 1 to 20, in particular from 6 to 15.

As described above, each R³ in the above formula can be different if x≧2. The alkylene oxide unit in square brackets can thereby be varied. If x denotes 3, for example, the residue R³ can be selected in order to form ethylene oxide units (R³═H) or propylene oxide (R³═CH₃) units, which can be fitted together in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected here by way of example, and can certainly be greater; the range of variation increases with rising values of x and includes, for example, a large number of (EO) groups combined with small number of (PO) groups, or vice versa.

Particularly preferred end-capped poly(oxyalkylated) alcohols of the above formula have values k=1 and j=1, so that the formula above becomes simplified to

R¹O[CH₂CH(R³)O]ₓCH₂CH(OH)CH₂OR².

In the latter formula, R¹, R², and R³ are as defined above and x denotes numbers from 1 to 30, preferably from 1 to 20, and in particular from 6 to 18. Surfactants in which the residues R¹ and R² have 9 to 14 carbon atoms, R³ denotes hydrogen, and x assumes values from 6 to 15, are particularly preferred.

Further nonionic surfactants preferred for use are nonionic surfactants of the general formula R¹O(AlkO)ₓM(OAIk)_{y}OR², where
R¹ and R² mutually independent denote a branched or unbranched, saturated or unsaturated, optionally hydroxylated alkyl residue having 4 to 22 carbon atoms;
Alk denotes a branched or unbranched alkyl residue having 2 to 4 carbon atoms;
x and y mutually independently denote values between 1 and 70; and
M denotes an alkyl residue from the group CH₂, CHR³, CR³R⁴, CH₂CHR³, and CHR³CHR⁴, where R³ and R⁴ mutually independently denote a branched or unbranched, saturated or unsaturated alkyl residue having 1 to 18 carbon atoms.

Preferred in this context are nonionic surfactants of the general formula R¹—CH(OH)CH₂—O(CH₂CH₂O)ₓCH₂CHR(OCH₂CH₂)_{y}O—CH₂CH(OH)—R², where
R, R¹, and R² mutually independently denote an alkyl residue or alkenyl residue having 6 to 22 carbon atoms;
x and y mutually independently denote values between 1 and 40.

Particularly preferred in this context are compounds of the general formula R¹—CH(OH)CH₂—O(CH₂CH₂O)ₓCH₂CHR(OCH₂CH₂)_{y}O—CH₂CH(OH)—R² in which R denotes a linear, saturated alkyl residue having 8 to 16 carbon atoms, preferably 10 to 14 carbon atoms, and n and m mutually independently have values from 20 to 30. Corresponding compounds can be obtained, for example, by reacting alkyl diols HO—CHR—CH₂—OH with ethylene oxide followed by reaction with an alkyl epoxide in order to close off the free OH functions, forming a dihydroxy ether.

In a further preferred embodiment, the nonionic surfactant is selected from nonionic surfactants of the general formula

R¹O(CH₂CH₂O)ₓCR³R⁴(OCH₂CH₂)_{y}O—R² in which
R¹ and R² mutually independently denote an alkyl residue or alkenyl residue having 4 to 22 carbon atoms;
R³ and R⁴ mutually independently denote hydrogen or an alkyl residue or alkenyl residue having 1 to 18 carbon atoms; and
x and y mutually independent denote values between 1 and 40.

Compounds of the general formula R¹O(CH₂CH₂O)ₓCR³R⁴(OCH₂CH₂)_{y}O—R² in which R³ and R⁴ denote hydrogen, and the indices x and y mutually independently assume values from 1 to 40, preferably from 1 to 15, are preferred here in particular.

In particular, compounds of the general formula R¹O(CH₂CH₂O)ₓCR³R⁴(OCH₂CH₂)_{y}O—R² in which the residues R¹ and R² mutually independently represent saturated alkyl residues having 4 to 14 carbon atoms, and the indices x and y mutually independently assume values from 1 to 15 and in particular from 1 to 12, are particularly preferred.

Also preferred are those compounds of the general formula R¹—O(CH₂CH₂O)ₓCR³R⁴(OCH₂CH₂)_{y}O—R² in which one of the residues R¹ and R² is branched.

Compounds of the general formula R¹—O(CH₂CH₂O)ₓCR³R⁴(OCH₂CH₂)_{y}O—R² in which the indices x and y mutually independently assume values from 8 to 12 are very particularly preferred.

The carbon chain lengths, and degrees of ethoxylation or alkoxylation, indicated for the aforesaid nonionic surfactants represent statistical averages that can be an integer or a fractional number for a specific product. As a result of the manufacturing method, commercial products of the formulas recited are usually made up not of an individual representative but rather of mixtures, which can result in averages and, as a consequence thereof, fractional numbers for both the carbon chain lengths and the degrees of ethoxylation or alkoxylation.

The aforesaid nonionic surfactants can of course be employed not only as individual substances but also as surfactant mixtures of two, three, four, or more surfactants. “Surfactant mixtures” refers not to mixtures of nonionic surfactants that are embraced in their totality by one of the aforesaid general formulas, but instead to those mixtures which contain two, three, four, or more nonionic surfactants that can be described by different ones of the aforesaid general formulas.

Those nonionic surfactants that have a melting point above room temperature are particularly preferred. Nonionic surfactant(s) having a melting point above 20° C., preferably above 25° C., particularly preferably between 25 and 60° C., and in particular between 26.6 and 43.3° C., is/are particularly preferred.

In a preferred embodiment, the weight proportion of the nonionic surfactant in terms of the total weight of the automatic dishwashing according to the present invention or in the context of use of an automatic rinse aid is from 0.1 to 20 wt %, particularly preferably from 0.5 to 15 wt %, in particular from 2.5 to 10 wt %.

In a preferred embodiment, the wt % ratio of anionic surfactant having at least one sulfate group or sulfonate group to nonionic surfactant is from 3:1 to 1:3, in particular from 2:1 to 1:2, particularly preferably from 1.5:1 to 1:1.5.

Rinse aids according to the present invention are preferably liquid and have an acid pH, preferably a pH from 3 to 6. Rinse aids according to the present invention accordingly preferably contain, besides the at least one nonionic surfactant and besides the at least one anionic surfactant having at least one sulfate group or sulfonate group, at least one acidifying agent. Both inorganic acids and organic acids are usable as acidifying agents. Preferred organic acids are the solid mono-, oligo-, and polycarboxylic acids. Acids particularly preferred for use are acetic acid, citric acid, tartaric acid, succinic acid, malonic acid, adipic acid, maleic acid, fumaric acid, glutaric acid, oxalic acid, polyacrylic acid, and mixtures thereof. Organic sulfonic acids such as amidosulfonic acid are likewise usable. The acidifying agent is used in rinse aids according to the present invention by preference in quantities from 0.1 to 12 wt %, preferably 0.2 to 10 wt %, and in particular 0.4 to 8.0 wt %.

Dishwashing methods according to the present invention are carried out preferably at a bath temperature below 60° C., preferably below 50° C. In a preferred embodiment, the dishwashing method lasts for a maximum of 90 minutes, in particular a maximum of 75 minutes, particularly preferably a maximum of 60 minutes. In particular embodiments, the dishwashing method lasts for a maximum of 50, 40, or 30 minutes.

Dishwashing agents according to the present invention contain, besides the at least one nonionic surfactant and besides the at least one anionic surfactant having at least one sulfate group or sulfonate group, a combination of at least one polycarboxylic acid, preferably citrate, and at least one further compound selected from MGDA, GLDA, and EDDS, especially a combination of citrate and MGDA, as builders.

Polycarboxylic acids can be used both in the form of the free acid and in the form of salts thereof, in particular as sodium salts. “Polycarboxylic acids” are understood according to the present invention as those carboxylic acids which carry more than one acid function; according to the present invention, MGDA, GLDA, and EDDS are not categorized among the polycarboxylic acids. Preferred polycarboxylic acids for purposes of the invention are citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess, besides their builder effect, the property of an acidifying component, and thus also serve to establish a lower and milder pH for washing or cleaning agents. To be mentioned in this context are, in particular, citric acid, succinic acid, glutaric acid, adipic acid, gluconic acid, and any mixtures thereof. Particularly preferred automatic dishwashing agents according to the present invention, in particular reduced-phosphate or phosphate-free, contain citrate as one of their essential builders. Automatic dishwashing agents characterized in that they contain 2 to 40 wt %, preferably 5 to 30 wt %, and in particular 7 to 20 wt % polycarboxylic acids, especially citrate, are preferred according to the present invention.

MGDA (methylglycinediacetic acid), GLDA (glutamic acid-N,N-diacetic acid), and EDDS (ethylenediamine-N,N′-disuccinic acid) are employed in automatic dishwashing agents according to the present invention preferably in quantities from 2 to 50 wt %, in particular in quantities from 4 to 40 wt %, particularly preferably in quantities from 6 to 25 wt %.

The automatic dishwashing agents according to the present invention are present preferably in the form of a shaped element, in particular a compactate, especially a tablet. They can also be present, however, in combination with other presentation forms, in particular in combination with solid presentation forms such as powders, granulates, or extrudates, or in combination with liquid presentation forms based on water and/or organic solvents.

The shaped element can also be, for example, a granulate that is contained in a pouch or a mold.

Agents according to the present invention can be formulated as single-phase or multi-phase products. Automatic dishwashing agents having one, two, three, or four phases are particularly preferred. Automatic dishwashing agents characterized in that they are present in the form of a prefabricated dispensing unit having two or more phases are particularly preferred. Two-phase or multi-phase tablets in particular, for example two-layer tablets, in particular two-layer tablets having a recess and a shaped element located in the recess, are particularly preferred.

Automatic dishwashing agents according to the present invention are preferably pre-formulated into dispensing units. These dispensing units preferably comprise the quantity of substances having washing or cleaning activity that is necessary for one cleaning cycle. Preferred dispensing units have a weight between 12 and 30 g, preferably between 14 and 26 g, and in particular between 15 and 22 g.

With particular preference, the volume of the aforesaid dispensing units, and their three-dimensional shape, are selected so that dispensability of the pre-formulated units via the dispensing chamber of an automatic dishwasher is guaranteed. The volume of the dispensing unit is therefore preferably between 10 and 35 ml, preferably between 12 and 30 ml, and in particular between 15 and 25 ml.

In a preferred embodiment, the automatic dishwashing agents according to the present invention, in particular the preformulated dispensing units, comprise a water-soluble envelope.

In a preferred embodiment, shaped elements according to the present invention contain polyvinylpyrrolidone particles. These particles, inter alia, facilitate disintegration of the shaped elements and serve in that regard as disintegration adjuvants or tablet bursting agents. It has proven to be particular advantageous according to the present invention to employ polyvinylpyrrolidone particles having an average particle diameter from 100 to 150 μm, in particular having an average particle diameter from 110 to 130 μm.

The term “average particle diameter” or “average diameter” is to be understood in the context of the present invention as the volume-average D₅₀ particle diameter, which can be determined with usual methods. The volume-average D₅₀ particle diameter is that point in the particle size distribution at which 50 vol % of the particles have a smaller diameter and 50 vol % of the particles have a larger diameter. The average particle diameter can be determined in particular with the aid of dynamic light scattering, which is usually carried out on diluted suspensions that contain, for example, 0.01 to 1 wt % particles.

Particularly preferably, not only do the PVP particles have an average particle diameter from 100 to 150 μm, in particular from 110 to 130 μm, but furthermore the particle size of the particles used preferably lies entirely within the ranges indicated.

This is ensured by using grain size fractions, having the particle sizes indicated, that were obtained using a sieving method.

The PVP particles are contained in compositions according to the present invention preferably in a quantity from 0.1 to 5 wt %, in particular in a quantity from 0.2 to 3 wt %, especially in a quantity from 0.3 to 1.8 wt %.

Further disintegration adjuvants known to the skilled artisan can also be employed, specifically (if used) preferably in quantities from 0.1 to 10 wt %, preferably 0.2 to 5 wt %, and in particular 0.5 to 2 wt %, based in each case on the total weight of the agent containing disintegration adjuvant.

In a preferred embodiment, the shaped element according to the present invention contains no further disintegration adjuvant besides the PVP particles.

In a preferred embodiment, automatic dishwashing agents according to the present invention contain as a further constituent at least one anionic polymer. Preferred anionic polymers are copolymeric polycarboxylates and copolymeric polysulfonates.

In a preferred embodiment, the weight proportion of the anionic polymer in terms of the total weight of the automatic dishwashing agent according to the present invention is from 0.1 to 20 wt %, preferably from 0.5 to 18 wt %, particularly from 1.0 to 15 wt %, and in particular from 4 to 14 wt %.

Automatic dishwashing agents according to the present invention characterized in that the copolymeric anionic polymer is selected from the group of hydrophobically modified polycarboxylates and polysulfonates, are a particularly preferred subject, since an improvement in the rinsing and drying properties of said agents, simultaneously with decreased deposit formation, can be achieved as a result of the hydrophobic modification of the anionic copolymers.

The copolymers can comprise two, three, four or more different monomer units.

Preferred copolymeric polysulfonates contain, besides sulfonic-acid-group-containing monomer(s), at least one monomer from the group of the unsaturated carboxylic acids.

Unsaturated carboxylic acid(s) used with particular preference are unsaturated carboxylic acids of the formula R¹(R²)C═C(R³)COOH in which R¹ to R³ mutually independently denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴ where R⁴ is a saturated or unsaturated, straight-chain or branched hydrocarbon residue having 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic acid anhydride, fumaric acid, itaconic acid, citraconic acid, methylenemalonic acid, sorbic acid, cinnamic acid, or mixtures thereof. The unsaturated dicarboxylic acids are of course also usable.

It is particularly preferred according to the present invention to use, as copolymeric polycarboxylates, copolymers of acrylic acid with methacrylic acid and of acrylic acid or methacrylic acid with maleic acid. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, preferably 20,000 to 50,000 g/mol, and in particular 30,000 to 40,000 g/mol.

In the context of the sulfonic acid group-containing monomers, those of the formula

R⁵(R⁶)C═C(R⁷)—X—SO₃H,

in which R⁵ to R⁷ mutually independently denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or denote —COOH or —COOR⁴, where R⁴ is a saturated or unsaturated, straight-chain or branched hydrocarbon residue having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₂CH₃)—, are preferred.

Among these monomers, those of the formulas

H₂C═CH—X—SO₃H

H₂C═C(CH₃)—X—SO₃H

HO₃S—X—(R⁶)C═C(R⁷)—X—SO₃—H,

in which R⁶ and R⁷ are selected mutually independently from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the aforesaid acids or water-soluble salts thereof.

The sulfonic acid groups can be present in the polymers entirely or partly in neutralized form, i.e. the acid hydrogen atom of the sulfonic acid group can be replaced, in some or all of the sulfonic acid groups, with metal ions, preferably alkali metal ions, and in particular with sodium ions. The use of partly or entirely neutralized sulfonic acid group-containing copolymers is preferred according to the present invention.

In the context of copolymers that contain only carboxylic acid group-containing monomers and sulfonic acid group-containing monomers, the monomer distribution of the copolymers preferably used according to the present invention is preferably 5 to 95 wt %; particularly preferably, the proportion of the sulfonic acid group-containing monomer is 50 to 90 wt % and the proportion of the carboxylic acid group-containing monomer is 10 to 50 wt %, the monomers preferably being selected from those recited above.

The molar mass of the sulfo-copolymers preferably used according to the present invention can be varied in order to adapt the properties of the polymers to the desired application. Preferred automatic dishwashing agents are characterized in that the copolymers have molar masses from 2000 to 200,000 gmol⁻¹, preferably from 4000 to 25,000 gmol⁻¹, and in particular from 5000 to 15,000 gmol⁻¹.

In a further preferred embodiment the copolymers also comprise, besides carboxyl group-containing monomers and sulfonic acid group-containing monomers, at least one nonionic, preferably hydrophobic monomer. The use of these hydrophobically modified polymers has made it possible to improve, in particular, the rinsing performance of automatic dishwashing agents according to the present invention.

Automatic dishwashing agents characterized in that the automatic dishwashing agent contains as an anionic copolymer a copolymer comprising
i) carboxylic acid group-containing monomer(s),
ii) sulfonic acid group-containing monomer(s),
iii) nonionic monomer(s),
   are preferred according to the present invention.

The nonionic monomers used are preferably monomers of the general formula R¹(R²)C═C(R³)—X—R⁴, in which R¹ to R³ mutually independently denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms.

Particularly preferred nonionic monomers are butene, isobutene, pentene, 3-methylbutene, 2-methylbutene, cyclopentene, hexene, hexene-1, 2-methlypentene-1, 3-methlypentene-1, cyclohexene, methylcyclopentene, cycloheptene, methylcyclohexene, 2,4,4-trimethylpentene-1, 2,4,4-trimethylpentene-2, 2,3-dimethylhexene-1, 2,4-dimethylhexene-1, 2,5-dimethlyhexene-1, 3,5-dimethylhexene-1, 4,4-dimethylhexane-1, ethylcyclohexyne, 1-octene, α-olefins having 10 or more carbon atoms such as, for example, 1-decene, 1-dodecene, 1-hexadecene, 1-octadecene, and C22-α-olefin, 2-styrene, α-methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

Dishwashing agents according to the present invention furthermore preferably contain further builder(s) and/or enzyme(s) in order to ensure their cleaning effect.

As a further constituent, automatic dishwashing agents according to the present invention preferably contain one or more further builder(s). The weight proportion of these further builders in terms of the total weight of automatic dishwashing agents according to the present invention is preferably 2 to 50 wt % and in particular 4 to 25 wt %. Included among these builders are, in particular, carbonates, phosphates, organic cobuilders, and silicates.

It is particularly preferred to use carbonate(s) and/or hydrogen carbonate(s), preferably alkali carbonate(s), particularly preferably sodium carbonate, in quantities from 2 to 30 wt %, preferably from 4 to 28 wt %, and in particular from 8 to 24 wt %, based in each case on the weight of the automatic dishwashing agent.

The use of phosphate is furthermore preferred. Among the plurality of commercially obtainable phosphates, the alkali metal phosphates, with particular preference for pentasodium or pentapotassium phosphate (sodium or potassium tripolyphosphate), have the greatest significance in the washing- and cleaning-agent industry.

“Alkali metal phosphates” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates combine a number of advantages: they act as alkali carriers, prevent lime deposits on machine parts or lime encrustations in fabrics, and furthermore contribute to cleaning performance.

Phosphates particularly preferred according to the present invention are pentasodium phosphate Na₅P₃O₁₀ (sodium tripolyphosphate) as well as the corresponding potassium salt pentapotassium triphosphate K₅P₃O₁₀. Sodium potassium tripolyphosphates are furthermore preferably used according to the present invention.

If phosphates are employed in the context of the present application in the automatic dishwashing agents as substances having washing or cleaning activity, the latter then contain phosphate(s), preferably alkali metal phosphate(s), particularly preferably pentasodium or pentapotassium triphosphate (sodium or potassium tripolyphosphate), in quantities from 5 to 60 wt %, preferably from 15 to 45 wt %, and in particular from 20 to 40 wt %, based in each case on the weight of the automatic dishwashing agent.

In an embodiment particularly preferred according to the present invention, however, the use of phosphates is largely or entirely dispensed with. In this embodiment the agent contains preferably less than 5 wt %, particularly preferably less than 3 wt %, in particular less than 1 wt % phosphate(s). Particularly preferably, in this embodiment the agent is entirely phosphate-free. These phosphate-free agents in particular have proven according to the present invention to be particularly advantageous for achieving the observed drying effect.

Also suitable as builders are polymeric polycarboxylates; these are, for example, the alkali metal salts of polyacrylic acid or of polymethacrylic acid, for example those having a relative molecular weight from 500 to 70,000 g/mol.

Suitable polymers are, in particular, polyacrylates that preferably have a molecular weight from 2000 to 20,000 g/mol. Of this group in turn, the short-chain polyacrylates, which have molar masses from 2000 to 10,000 g/mol, and particularly preferably from 3000 to 5000 g/mol, can be preferred because of their superior solubility.

The (homo)polymeric polycarboxylate content of the automatic dishwashing agents is preferably 0.5 to 20 wt % and in particular 3 to 10 wt %.

A hydroxyalkane- and/or aminoalkanephosphonate is preferably employed as a phosphonate compound. Among the hydroxyalkanephosphonates, 1-hydroxyethane-1, 1-diphosphonate (HEDP) is of particular significance. Appropriate aminoalkanephosphonates are preferably ethylenediaminetetramethylenephosphonate (EDTMP), diethylenetriaminepentamethylenephosphonate (DTPMP), and higher homologs thereof. Phosphonates are contained in agents according to the present invention preferably in quantities from 0.1 to 10 wt %, in particular in quantities from 0.5 to 8 wt %, based in each case on the total weight of the dishwashing agent.

Automatic dishwashing agents according to the present invention can furthermore contain crystalline sheet silicates of the general formula NaMSiₓO₂ₓ₊₁.yH₂O, in which M represents sodium or hydrogen, x denotes a number from 1.9 to 22, preferably from 1.9 to 4, where particularly preferred values for x are 2, 3, or 4, and y denotes a number from 0 to 33, preferably from 0 to 20, as a builder. Also usable are amorphous sodium silicates having a Na₂O:SiO₂ modulus from 1:2 to 1:3.3, preferably from 1:2 to 1:2.8, and in particular from 1:2 to 1:2.6, which are preferably dissolution-delayed and exhibit secondary washing properties.

In preferred automatic dishwashing agents according to the present invention the concentration of silicates, based on the total weight of the automatic dishwashing agent, is limited to quantities below 10 wt %, preferably below 5 wt %, and in particular below 2 wt %. Particularly preferred automatic dishwashing agents according to the present invention are silicate-free.

As a supplement to the aforesaid builders, the agents according to the present invention can contain alkali metal hydroxides. These alkali carriers are employed in the cleaning agents preferably only in small quantities, preferably in quantities below 10 wt %, by preference below 6 wt %, preferably below 5 wt %, particularly preferably between 0.1 and 5 wt %, and in particular between 0.5 and 5 wt %, based in each case on the total weight of the cleaning agent. Alternative automatic dishwashing agents are free of alkali metal hydroxides.

Dishwashing agents according to the present invention preferably contain enzyme(s) as a further constituent. These include in particular proteases, amylases, lipases, hemicellulases, cellulases, perhydrolases, or oxidoreductaxes, as well as preferably mixtures thereof. These enzymes are in principle of natural origin; proceeding from the natural molecules, improved variants are available for use in washing or cleaning agents and are used in correspondingly preferred fashion. Washing or cleaning agents contain enzymes preferably in total quantities from 1×10⁻⁶ to 5 wt % based on active protein. The protein concentration can be determined with the aid of known methods, for example the BCA method or the biuret method.

A protein and/or enzyme can be protected, especially during storage, from damage such as, for example, inactivation, denaturing, or decomposition, e.g. resulting from physical influences, oxidation, or proteolytic cleavage. An inhibition of proteolysis is particularly preferred in the context of microbial recovery of the proteins and/or enzymes, in particular when the agents also contain proteases. Washing or cleaning agents can contain stabilizers for this purpose; the provision of such agents represents a preferred embodiment of the present invention.

Amylases and proteases having washing or cleaning activity are furnished as a rule not in the form of the pure protein but instead in the form of stabilized, storable and transportable preparations. Included among these prepackaged preparations are, for example, the solid preparations obtained by granulation, extrusion, or lyophilization or, in particular in the case of liquid or gelled agents, solutions of the enzymes, advantageously as concentrated as possible, low in water and/or with added stabilizers or other adjuvants.

Alternatively, the enzymes can be encapsulated for both the solid and the liquid administration form, for example by spray drying or extrusion of the enzyme solution together with a preferably natural polymer, or in the form of capsules, for example those in which the enzymes are enclosed e.g. in a solidified gel, or in those of the core-shell type, in which an enzyme-containing core is coated with a water-, air-, and/or chemical-impermeable protective layer. Further active agents, for example stabilizers, emulsifiers, pigments, bleaches, or dyes, can additionally be applied in superimposed layers. Such capsules are applied using methods known per se, for example by vibratory or roll granulation or in fluidized bed processes. Advantageously, such granulates are low in dust, for example as a result of the application of polymeric film-formers, and are shelf-stable because of the coating.

It is furthermore possible to package two or more enzymes together, so that a single granulate exhibits multiple enzyme activities.

As is apparent from the statements above, the enzyme protein constitutes only a fraction of the total weight of usual enzyme preparations. Protease and amylase preparations preferably used according to the present invention contain between 0.1 and 40 wt %, preferably between 0.2 and 30 wt %, particularly preferably between 0.4 and 20 wt %, and in particular between 0.8 and 10 wt % of the enzyme protein.

Those automatic dishwashing agents that contain, based in each case on their total weight, 0.1 to 12 wt %, preferably 0.2 to 10 wt %, and in particular 0.5 to 8 wt % enzyme preparations are preferred in particular.

Particularly preferred automatic rinse aids according to the present invention have a pH from 3 to 6 and contain
a) 2.6 to 9.9 wt %, preferably 3.0 to 9.5 wt %, in particular 4.0 to 8.0 wt % anionic surfactant(s) selected from alkyl sulfates, alkylsulfonates, and alkylbenzenesulfonates;
b) 0.1 to 20 wt %, preferably 0.5 to 15 wt %, in particular 2.5 to 10 wt % nonionic surfactant(s) comprising a linear or branched alkyl residue having 10 to 20, preferably 12 to 18 carbon atoms, as well as 2 to 30, preferably 4 to 15 ethylene oxide units, and optionally up to 5, in particular up to 2 propylene oxide units and up to 5, in particular up to 2 butylene oxide units;
c) optionally 0.1 to 12 wt %, preferably 0.2 to 10 wt % acidifying agent(s), selected in particular from organic acids.

Particularly preferred automatic dishwashing agents according to the present invention contain
a) 2.6 to 9.9 wt %, preferably 3.0 to 9.5 wt %, in particular 4.0 to 8.0 wt % anionic surfactant(s) having at least one sulfate group or sulfonate group, preferably selected from alkyl sulfates, alkylsulfonates, and alkylbenzenesulfonates, in particular from C₁₂ to C₁₈ fatty alcohol sulfates, secondary C₁₃ to C₁₇ alkanesulfonates, and linear C₈ to C₁₈ alkylbenzenesulfonates;
b) 0.1 to 20 wt %, preferably 0.5 to 15 wt %, in particular 2.5 to 10 wt % nonionic surfactant(s) of the general formula

R¹O[CH₂CH(CH₃)O]ₓ[CH₂CH₂O]_{y}[CH₂CH(CH₃)O]_{z}CH₂CH(OH)R²,

in which R¹ denotes a linear or branched aliphatic hydrocarbon residue having 4 to 22, in particular 6 to 18 carbon atoms, or mixtures thereof, R² denotes a linear or branched hydrocarbon residue having 2 to 26, in particular 4 to 20 carbon atoms, or mixtures thereof, and x and z denote values between 0 and 40 and y denotes a value from 15 to 120, in particular from 20 to 80.

Besides the ingredients described previously, the dishwashing agents according to the present invention can contain further substances having washing or cleaning activity, preferably from the group of bleaching agents, bleach activators, and bleach catalysts, glass corrosion inhibitors, corrosion inhibitors, scents, and perfume carriers. These preferred ingredients are described below in further detail.

The active-agent combinations described above are suitable in particular for cleaning dishes in automatic dishwashing methods. A further subject of the present application is therefore a method for cleaning dishes in an automatic dishwasher employing a dishwashing agent according to the present invention, where the dishwashing agent is dispensed into the interior of an automatic dishwasher preferably during execution of a dishwashing program, before the main cleaning cycle begins, or in the course of the main cleaning cycle. Dispensing or introduction of the agent according to the present invention into the interior of the automatic dishwasher can occur manually; preferably, however, the agent is dispensed into the interior of the automatic dishwasher by means of the automatic dishwasher's dispensing chamber. Preferably, no additional water softener and no additional rinsing agent is dispensed into the interior of the automatic dishwasher in the course of the cleaning method.

A kit for an automatic dishwasher, comprising
a) an automatic dishwashing agent according to the present invention;
b) an instruction informing the consumer that the automatic dishwashing agent is to be used without addition of a rinse aid and/or of a softener salt,
   is a further subject of this application.

The automatic dishwashing agents according to the present invention also exhibit their advantageous cleaning properties in particular in low-temperature cleaning methods and in the context of short-duration cleaning methods. Preferred dishwashing methods employing agents according to the present invention are therefore characterized in that the dishwashing methods are carried out at a bath temperature below 60° C., preferably below 50° C., and/or have a duration of less than 90 minutes, preferably less than 60 minutes, in particular less than 45 minutes.

Some exemplifying formulas for preferred automatic dishwashing agent tablets according to the present invention may be gathered from the tables below:

| | Formula 1 | Formula 2 | Formula 3 | Formula 4 |
|---|---|---|---|---|
| Ingredient | (wt %) | (wt %) | (wt %) | (wt %) |
| MGDA | 5 to 50 | 15 to 40 | — | — |
| GLDA | — * | — | 5 to 50 | — |
| EDDS | — | — | — | 5 to 50 |
| Citrate | 5 to 40 | 15 to 30 | 5 to 40 | 5 to 40 |
| Carbonate | 2 to 45 | 2 to 35 | 2 to 45 | 2 to 35 |
| Phosphonate | 0.1 to 10 | 0.5 to 8 | 0.1 to 10 | 0.5 to 8 |
| Enzyme ** | 0.2 to 10 | 0.2 to 10 | 0.5 to 8 | 0.5 to 8 |
| Nonionic | 0.05 to 10 | 0.05 to 10 | 0.05 to 10 | 0.05 to 10 |
| surfactant A ¹ | | | | |
| LAS, SAS or | 2.6 to 9.9 | 3.0 to 9.5 | 2.6 to 9.9 | 3.0 to 9.5 |
| FAS | | | | |
| Misc. | to 100 | to 100 | to 100 | to 100 |

| | Formula 5 | Formula 6 | Formula 7 | Formula 8 |
|---|---|---|---|---|
| Ingredient | (wt %) | (wt %) | (wt %) | (wt %) |
| MGDA | 5 to 50 | 15 to 40 | — | — |
| GLDA | — * | — | 5 to 50 | — |
| EDDS | — | — | — | 5 to 50 |
| Citrate | 5 to 40 | 15 to 30 | 5 to 40 | 5 to 40 |
| Carbonate | 2 to 45 | 2 to 35 | 2 to 45 | 2 to 35 |
| Phosphonate | 0.1 to 10 | 0.5 to 8 | 0.1 to 10 | 0.5 to 8 |
| Enzyme ** | 0.2 to 10 | 0.2 to 10 | 0.5 to 8 | 0.5 to 8 |
| Nonionic | 0.05 to 10 | 0.05 to 10 | 0.05 to 10 | 0.05 to 10 |
| surfactant A ^{1a} | | | | |
| LAS, SAS or | 2.6 to 9.9 | 3.0 to 9.5 | 2.6 to 9.9 | 3.0 to 9.5 |
| FAS | | | | |
| Misc. | to 100 | to 100 | to 100 | to 100 |

| | Formula 9 | Formula 10 | Formula 11 | Formula 12 |
|---|---|---|---|---|
| Ingredient | (wt %) | (wt %) | (wt %) | (wt %) |
| MGDA | 5 to 50 | 15 to 40 | — | — |
| GLDA | — * | — | 5 to 50 | — |
| EDDS | — | — | — | 5 to 50 |
| Citrate | 5 to 40 | 15 to 30 | 5 to 40 | 5 to 40 |
| Carbonate | 2 to 45 | 2 to 35 | 2 to 45 | 2 to 35 |
| Phosphonate | 0.1 to 10 | 0.5 to 8 | 0.1 to 10 | 0.5 to 8 |
| Enzyme ** | 0.2 to 10 | 0.2 to 10 | 0.5 to 8 | 0.5 to 8 |
| Nonionic | 0.05 to 10 | 0.05 to 10 | 0.05 to 10 | 0.05 to 10 |
| surfactant B ² | | | | |
| LAS, SAS or | 2.6 to 9.9 | 3.0 to 9.5 | 2.6 to 9.9 | 3.0 to 9.5 |
| FAS | | | | |
| Misc. | to 100 | to 100 | to 100 | to 100 |

| | Formula 13 | Formula 14 | Formula 15 | Formula 16 |
|---|---|---|---|---|
| Ingredient | (wt %) | (wt %) | (wt %) | (wt %) |
| MGDA | 5 to 50 | 15 to 40 | — | — |
| GLDA | — * | — | 5 to 50 | — |
| EDDS | — | — | — | 5 to 50 |
| Citrate | 5 to 40 | 15 to 30 | 5 to 40 | 5 to 40 |
| Carbonate | 2 to 45 | 2 to 35 | 2 to 45 | 2 to 35 |
| Phosphonate | 0.1 to 10 | 0.5 to 8 | 0.1 to 10 | 0.5 to 8 |
| Enzyme ** | 0.2 to 10 | 0.2 to 10 | 0.5 to 8 | 0.5 to 8 |
| Nonionic | 0.05 to 10 | 0.05 to 10 | 0.05 to 10 | 0.05 to 10 |
| surfactant A ¹ | | | | |
| Anionic | 0.5 to 18 | 0.5 to 18 | 0.5 to 18 | 0.5 to 18 |
| copolymer C ³ | | | | |
| LAS, SAS or | 2.6 to 9.9 | 3.0 to 9.5 | 2.6 to 9.9 | 3.0 to 9.5 |
| FAS | | | | |
| Misc. | to 100 | to 100 | to 100 | to 100 |

| | Formula 17 | Formula 18 | Formula 19 | Formula 20 |
|---|---|---|---|---|
| Ingredient | (wt %) | (wt %) | (wt %) | (wt %) |
| MGDA | 5 to 50 | 15 to 40 | — | — |
| GLDA | — * | — | 5 to 50 | — |
| EDDS | — | — | — | 5 to 50 |
| Citrate | 5 to 40 | 15 to 30 | 5 to 40 | 5 to 40 |
| Carbonate | 2 to 45 | 2 to 35 | 2 to 45 | 2 to 35 |
| Phosphonate | 0.1 to 10 | 0.5 to 8 | 0.1 to 10 | 0.5 to 8 |
| Enzyme ** | 0.2 to 10 | 0.2 to 10 | 0.5 to 8 | 0.5 to 8 |
| Nonionic | 0.05 to 10 | 0.05 to 10 | 0.05 to 10 | 0.05 to 10 |
| surfactant A ¹ | | | | |
| Nonionic | 1 to 10 | 1 to 10 | 1 to 10 | 1 to 10 |
| surfactant B ² | | | | |
| Anionic | 0.5 to 18 | 0.5 to 18 | 0.5 to 18 | 0.5 to 18 |
| copolymer C ³ | | | | |
| LAS, SAS or | 2.6 to 9.9 | 3.0 to 9.5 | 2.6 to 9.9 | 3.0 to 9.5 |
| FAS | | | | |
| Misc. | to 100 | to 100 | to 100 | to 100 |

| | Formula 21 | Formula 22 | Formula 23 | Formula 24 |
|---|---|---|---|---|
| Ingredient | (wt %) | (wt %) | (wt %) | (wt %) |
| MGDA | 5 to 50 | 15 to 40 | — | — |
| GLDA | — * | — | 5 to 50 | — |
| EDDS | — | — | — | 5 to 50 |
| Citrate | 5 to 40 | 15 to 30 | 5 to 40 | 5 to 40 |
| Carbonate | 2 to 45 | 2 to 35 | 2 to 45 | 2 to 35 |
| Phosphonate | 0.1 to 10 | 0.5 to 8 | 0.1 to 10 | 0.5 to 8 |
| Nonionic | 0.05 to 10 | 0.05 to 10 | 0.05 to 10 | 0.05 to 10 |
| surfactant A ¹ | | | | |
| Nonionic | 1 to 10 | 1 to 10 | 1 to 10 | 1 to 10 |
| surfactant B ² | | | | |
| Anionic | 0.5 to 18 | 0.5 to 18 | 0.5 to 18 | 0.5 to 18 |
| copolymer C ³ | | | | |
| LAS, SAS or | 2.6 to 9.9 | 3.0 to 9.5 | 2.6 to 9.9 | 3.0 to 9.5 |
| FAS | | | | |
| Sodium | 2 to 30 | 2 to 30 | 4 to 20 | 4 to 20 |
| percarbonate | | | | |
| Bleach catalyst | 0 to 2 | 0.0025 to 1 | 0 to 2 | 0.0025 to 1 |
| Misc. | to 100 | to 100 | to 100 | to 100 |

| | Formula 25 | Formula 26 | Formula 27 | Formula 28 |
|---|---|---|---|---|
| Ingredient | (wt %) | (wt %) | (wt %) | (wt %) |
| MGDA | 5 to 50 | 15 to 40 | — | — |
| GLDA | — * | — | 5 to 50 | — |
| EDDS | — | — | — | 5 to 50 |
| Citrate | 5 to 40 | 15 to 30 | 5 to 40 | 5 to 40 |
| Carbonate | 2 to 45 | 2 to 35 | 2 to 45 | 2 to 35 |
| Phosphonate | 0.1 to 10 | 0.5 to 8 | 0.1 to 10 | 0.5 to 8 |
| Nonionic | 0.05 to 10 | 0.05 to 10 | 0.05 to 10 | 0.05 to 10 |
| surfactant A ^{1a} | | | | |
| Nonionic | 1 to 10 | 1 to 10 | 1 to 10 | 1 to 10 |
| surfactant B ^{2a} | | | | |
| Anionic | 0.5 to 18 | 0.5 to 18 | 0.5 to 18 | 0.5 to 18 |
| copolymer C ^{3a} | | | | |
| LAS, SAS or | 2.6 to 9.9 | 3.0 to 9.5 | 2.6 to 9.9 | 3.0 to 9.5 |
| FAS | | | | |
| Misc. | to 100 | to 100 | to 100 | to 100 |

| | Formula 29 | Formula 30 | Formula 31 | Formula 32 |
|---|---|---|---|---|
| Ingredient | (wt %) | (wt %) | (wt %) | (wt %) |
| MGDA | 5 to 50 | 15 to 40 | — | — |
| GLDA | — * | — | 5 to 50 | — |
| EDDS | — | — | — | 5 to 50 |
| Citrate | 5 to 40 | 15 to 30 | 5 to 40 | 5 to 40 |
| Carbonate | 2 to 45 | 2 to 35 | 2 to 45 | 2 to 35 |
| Phosphonate | 0.1 to 10 | 0.5 to 8 | 0.1 to 10 | 0.5 to 8 |
| Nonionic | 0.05 to 10 | 0.05 to 10 | 0.05 to 10 | 0.05 to 10 |
| surfactant A ^{1a} | | | | |
| Nonionic | 1 to 10 | 1 to 10 | 1 to 10 | 1 to 10 |
| surfactant B ^{2b} | | | | |
| Anionic | 0.5 to 18 | 0.5 to 18 | 0.5 to 18 | 0.5 to 18 |
| copolymer C ^{3a} | | | | |
| LAS, SAS or | 2.6 to 9.9 | 3.0 to 9.5 | 2.6 to 9.9 | 3.0 to 9.5 |
| FAS | | | | |
| Misc. | to 100 | to 100 | to 100 | to 100 |

¹A nonionic surfactant A of the general formula R¹O[CH₂CH(CH₃)O]ₓ[CH₂CH₂O]_{y}[CH₂CH(CH₃)O]_{z}CH₂CH(OH)R² in which R¹ denotes a linear or branched aliphatic hydrocarbon residue having 4 to 22 carbon atoms, or mixtures thereof, R² designates a linear or branched hydrocarbon residue having 2 to 26 carbon atoms, or mixtures thereof, and x and z denote values between 0 and 40 and y denotes a value of at least 15.
^{1a}A nonionic surfactant of the general formula R¹O[CH₂CH₂O]_{y}CH₂CH(OH)R² in which R¹ denotes a linear or branched aliphatic hydrocarbon residue having 4 to 22 carbon atoms, or mixtures thereof, R² denotes a linear or branched hydrocarbon residue having 2 to 26 carbon atoms, or mixtures thereof, and y denotes a value between 15 to 80.
²A nonionic surfactant B of the general formula R¹O(AlkO)ₓM(OAIk)_{y}OR² in which
   R¹ and R² mutually independently denote a branched or unbranched, saturated or unsaturated, optionally hydroxylated alkyl residue having 4 to 22 carbon atoms;
   Alk denotes a branched or unbranched alkyl residue having 2 to 4 carbon atoms;
   x and y mutually independently denote values between 1 and 70; and
   M denotes an alkyl residue from the group CH₂, CHR³, CR³R⁴, CH₂CHR³, and CHR³CHR⁴, where R³ and R⁴ mutually independently denote a branched or unbranched, saturated or unsaturated alkyl residue having 1 to 18 carbon atoms.
^{2a}A nonionic surfactant B of the general formula R¹—CH(OH)CH₂—O(CH₂CH₂O)ₓCH₂CHR(OCH₂CH₂)_{y}O—CH₂CH(OH)—R² in which
   R, R¹, and R² mutually independently denote an alkyl residue or alkenyl residue having 6 to 22 carbon atoms;
   x and y mutually independently denote values between 1 and 40.
^{2b}A nonionic surfactant B of the general formula R¹—O(CH₂CH₂O)ₓCR³R⁴(OCH₂CH₂)_{y}O—R², in which
   R, R¹, and R² mutually independently denote an alkyl residue or alkenyl residue having 4 to 22 carbon atoms;
   R³ and R⁴ mutually independently denote hydrogen or an alkyl residue or alkenyl residue having 1 to 18 carbon atoms, and
   x and y mutually independently denote values between 1 and 40.
³An anionic polymer C from the group of the copolymeric polycarboxylates and copolymeric polysulfonates.
^{3a}An anionic polymer C comprising
   i) carboxylic acid group-containing monomer(s),
   ii) sulfonic acid group-containing monomer(s),
   iii) optionally, nonionic monomer(s).
*“--” signifies that the formula is free of that constituent.

LAS denotes a linear C₈ to C₁₈ alkylbenzenesulfonate, SAS a secondary C₁₃ to C₁₇ alkanesulfonate, and FAS a C₁₂ to C₁₈ fatty alcohol sulfate.

### EXEMPLIFYING EMBODIMENT

### Example 1

### Drying Performance

The drying performance of a phosphate-free automatic dishwashing agent tablet that contained an end-capped nonionic surfactant along with citrate and GBDA as builders, and to which 5 wt % of a fatty alcohol sulfate had been added as an anionic surfactant, was tested. For comparison, the drying performance of the same dishwashing agent without anionic surfactant was tested.

The dishwashing method was carried out in a Bosch SMS 86M12DE dishwasher (program: 50° C., water hardness 21° dH) using 50 g ballast soil. The dishwashing agent tablet was placed into the dispensing apparatus before the cleaning program began. The fourth to sixth cleaning cycle was evaluated in each case, after completion of the respective cleaning cycle, on a scale from 0 to 6, where “0” signifies “no drops on the substrate, “1” “one drop on the substrate,” etc., and “6” signifies “six or more drops.”

The drying results are presented in the table below:

| | | Stainless | | | |
|---|---|---|---|---|---|
| | Glass | steel | Chinaware | Plastic | Average |
| Dishwashing | 3.22 | 3.08 | 3.94 | 6.00 | 4.06 |
| agent tablet | | | | | |
| +1 g Sulfopon | 3.22 | 3.66 | 2.99 | 6.00 | 3.70 |
| 1214G | | | | | |

Sulfopon 1214G is a C₁₂ to C₁₈ fatty alcohol sulfate (FAS).

Addition of the anionic surfactant results in an appreciable improvement in drying performance, in particular with respect to chinaware. The foaming of the anionic surfactant in the automatic dishwasher is obviously so minor that the drying performance is not negatively influenced thereby.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An automatic dishwashing agent, comprising at least one anionic surfactant having at least one sulfate group or sulfonate group, at least one nonionic surfactant, and, as builders, a combination of at least one polycarboxylic acid and at least one compound selected from the group consisting of methylglycinediacetic acid (MGDA) or salt thereof, glutaminediacetic acid (GLDA) or salt thereof, and ethylenediaminedisuccinic acid (EDDS) or salt thereof.

2. The automatic dishwashing agent according to claim 1, wherein the anionic surfactant is selected from alkyl sulfates, alkyl ether sulfates, alkylsulfonates, and alkylbenzenesulfonates, in a quantity from 0.1 to 20 wt %.

3. The automatic dishwashing agent according to claim 1, wherein the nonionic surfactant is selected from nonionic surfactants of the general formula R¹O[CH₂CH(CH₃)O]ₓ[CH₂CH₂O]_{y}[CH₂CH(CH₃)O]_{z}CH₂CH(OH)R², in which R¹ denotes a linear or branched aliphatic hydrocarbon residue having 4 to 22 carbon atoms, or mixtures thereof, R² denotes a linear or branched hydrocarbon residue having 2 to 26 carbon atoms, or mixtures thereof, and x and z denote values between 0 and 40 and y denotes a value from 15 to 120;
and from nonionic surfactants of the general formula R¹O(AlkO)ₓM(OAIk)_{y}OR², where R¹ and R² mutually independently denote a branched or unbranched, saturated or unsaturated, optionally hydroxylated alkyl residue having 4 to 22 carbon atoms; Alk denotes a branched or unbranched alkyl residue having 2 to 4; x and y mutually independently denote values between 1 and 70; and M denotes an alkyl residue from the group CH₂, CHR³, CR³R⁴, CH₂CHR³, and CHR³CHR⁴, where R³ and R⁴ mutually independently denote a branched or unbranched, saturated or unsaturated alkyl residue having 1 to 18 carbon atoms;
and the nonionic surfactant is preferably contained in a quantity from 0.1 to 20 wt %.

4. The automatic dishwashing agent according to claim 1, wherein the builders comprise a combination of citrate and at least one compound selected from MGDA, GLDA, and EDDS, and wherein the citrate comprises a quantity from 2 to 40 wt %.

5. The automatic dishwashing agent according to claim 1, comprising at least one constituent having cleaning action selected from salts of carbonic acid, bleaching agents, bleach activators, bleach catalysts, polymers, and enzymes.

6. An automatic dishwashing method, wherein the automatic dishwashing agent according to claim 1 is dispensed into the interior of an automatic dishwasher during execution of a dishwashing program.

7. The automatic dishwashing method according to claim 6 wherein the dishwashing agent comprises a combination of at least one anionic surfactant having at least one sulfate group or sulfonate group and at least one nonionic surfactant.
